(19) United States
(12) Patent Application Publication
(10) Pub. No.: US 2017/0050327 A1
(43) Pub. Date: Feb. 23, 2017

(54) SHAVING RAZOR WITH BLADE SHAVING GEL AND GEL APPLICATOR ASSEMBLED AS A UNIT

(71) Applicant: Ryan R. Alam, Houston, TX (US)

(72) Inventor: Ryan R. Alam, Houston, TX (US)

(21) Appl. No.: 14/828,783

(22) Filed: Aug. 18, 2015

(51) Int. Cl. B26B 21/44; B26B 21/14

(52) U.S. Cl. CPC B26B 21/446; B26B 21/14

(57) ABSTRACT

A shaving razor includes a razor blade and an applicator mounted to a user handle on opposed sides of one end of the user handle. A container of shaving lubricant is disposed in the user handle. A dispensing plunger is disposed in the user handle and is operable to displace shaving lubricant from the container. The container is in fluid communication with the applicator whereby displacement of the shaving lubricant from the container moves the shaving lubricant into the applicator.

### CROSS REFERENCE TO RELATED APPLICATIONS

Not Applicable.

### STATEMENT REGARDING FEDERALLY SPONSORED RESEARCH OF DEVELOPMENT

Not Applicable.

### NAMES TO THE PARTIES TO A JOINT RESEARCH AGREEMENT

Not Applicable.

### BACKGROUND

This disclosure relates generally to shaving using a razor blade with shaving gel or similar shaving lubricant. More specifically, the disclosure relates to a razor assembly in which a blade or blades, shaving gel and gel applicator are assembled into a single unit for convenient shaving.

Razor blade shaving known in the art includes using a razor having one or more blades mounted to a handle and shaving lubricant such as a shaving gel stored in a separate canister. The shaving gel is dispensed from the canister onto a user's fingers and then spread over the user's face or other skin surface to be shaved. Shaving gel tends to cling to the user's fingers which makes it necessary for the user to wash his hands before handling the razor. If a second application of shaving gel is required, these steps must be repeated.

Current air travel regulations in the United States require that passengers traveling in aircraft may only carry on board a maximum size three fluid ounce (89 ml) container of shaving gel, which is often more expensive per unit volume than conventional size containers (12 fluid ounces or 355 ml).

There is at present no conventional shaving razor that provides for a combination of razor blade(s) and shaving lubricant in a single instrument.

### BRIEF DESCRIPTION OF THE DRAWINGS

FIGS. 1 through 5 show various views of an example embodiment of an assembled shaving razor according to the present disclosure.

FIG. 6 shows an example embodiment of a handle of the assembled shaving razor shown in FIGS. 1 through 5.

FIG. 7 shows an example embodiment of a top washer for the handle shown in

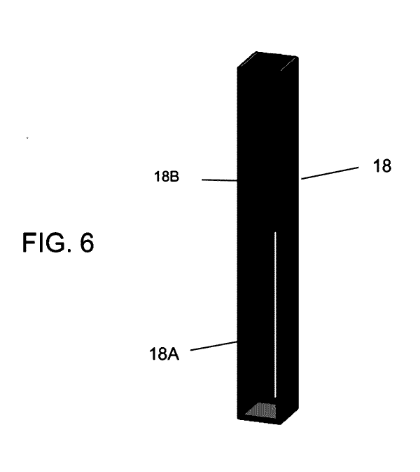

FIG. 6.

FIG. 8 shows an example embodiment of a shaving lubricant (gel) cartridge.

FIG. 9 shows an example embodiment of a dispensing plunger used with the cartridge of FIG. 8.

FIG. 10 shows an example embodiment of a handle that may be used with the dispensing plunger of FIG. 9.

FIGS. 11 and 12 show various views of a bracket used to hold both a razor blade and a shaving lubricant applicator to the handle of FIG. 6.

FIG. 13 shows an example embodiment of an applicator sponge mounting base.

FIG. 14 shows an example embodiment of an applicator sponge.

FIGS. 15 and 16 show various views of an example embodiment of a razor blade assembly.

### DETAILED DESCRIPTION

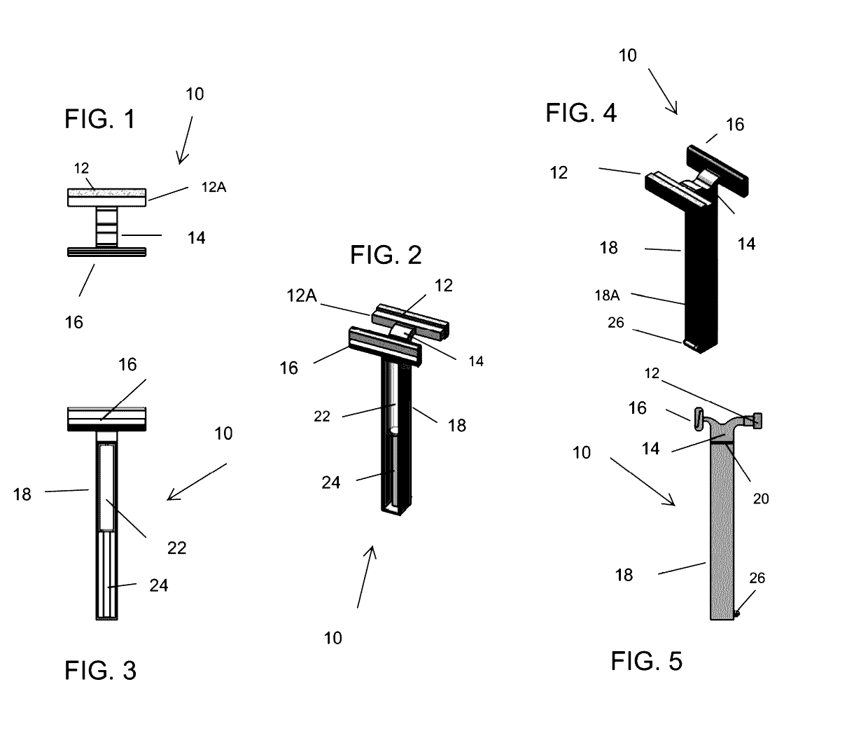

FIGS. 1 through 5 show various views of a shaving razor 10 according to the present disclosure. A top view shown in FIG. 1 illustrates a double sided mounting head 14, on one side of which a razor blade assembly 16 (shown in more detail in FIGS. 15 and 16) may be affixed. Any form of affixing may be used, including without limitation, adhesive bonding, thermal fusion of plastic parts, tack welding of metal parts and spring clips. The other side of the mounting head 14 may have coupled or mounted thereon an applicator base 12A to which may be affixed an applicator 12. The applicator base 12A may be affixed to the other side of the mounting head 14 in any manner such as the examples described with reference to mounting the razor blade assembly 16. The applicator 12 may be affixed to the applicator base 12A, for example, by adhesive bonding as will be explained with reference to FIG. 13.

FIG. 2 shows an oblique view of the shaving razor 10. A user handle 18 may be affixed to the mounting head 14 as will be further explained below. The respective positions of the razor blade assembly 16 and the applicator 12 (attached to the applicator base 12A) may be observed in FIG. 2. FIG. 2 shows that the user handle 18 may include an internal compartment (18B in FIG. 6) in which may be disposed a container 22 having therein a selected amount of shaving lubricant (e.g., gel). A dispensing plunger 24 may be disposed in the internal compartment and be in contact with the container 22 to enable. The compartment (18B in FIG. 6) may be left uncovered as shown in FIG. 2 or may be subsequently covered, e.g., with an adhesively or thermally bonded cover (not shown). The compartment (18B in FIG. 6) may be configured such that an empty container 22 can be removed and replaced with a full container 22, the dispensing tip (22A in FIG. 8) of which can be threaded or slipped on inside the compartment (18B in FIG. 6) and connected to the mounting head 14 as will be further explained below.

FIG. 3 shows a side view of the shaving razor 10 to more clearly illustrate the relative positions of the container 22 and the dispensing plunger 24 inside the user handle 18.

FIG. 4 shows an opposed oblique view of the shaving razor 10 as the view in FIG. 2 wherein may be observed a dispenser handle 26 coupled to the dispensing plunger 24. The dispenser handle 26 may be moved upwardly, i.e., toward the mounting head 14 to dispense shaving gel or other shaving lubricant from the container (22 in FIG. 3). FIG. 5 shows a side view of the shaving razor 10 rotated 90 degrees from the view shown in FIG. 3, wherein a mounting plate 20 may be disposed between the upper end face of the user handle 18 and the bottom face of the mounting head 14. The mounting plate 20 may be, for example, a plastic plate coated on both sides thereof with adhesive to strengthen the coupling between the user handle 18 and the mounting head 14.

FIG. 6 shows an oblique view of the user handle 18, wherein may be observed the compartment 18B for the container (22 in FIG. 3) and the dispensing plunger (24 in FIG. 3). While the user handle 18 and the compartment 18B are shown in FIG. 6 as having an approximately square cross-section, the shape of the cross-section is not a limit on the scope of the present disclosure. Any suitable cross-section that provides access for the container (22 in FIG. 3) and dispensing plunger (24 in FIG. 3) may be used to equal effect. In some embodiments, for example, an opening may be located at the bottom of the user handle 18 and the container (22 in FIG. 3) and dispensing plunger (24 in FIG. 3) inserted therethrough, whereupon the compartment 18B may be covered with a suitably affixed cover (not shown). In such embodiments the cross-section of the user handle 18 may be, for example, ovoid or circular. A slot 18A in the side of the user handle 18 may be provided for an operating pin (24B in FIG. 9) on the dispensing plunger (24 in FIG. 3) to enable the dispensing plunger (24 in FIG. 3) to be moved by the user pushing upwardly on the dispenser handle (26 in FIG. 5).

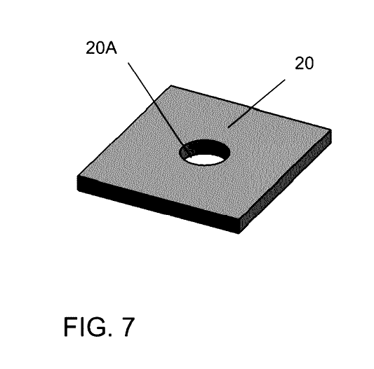

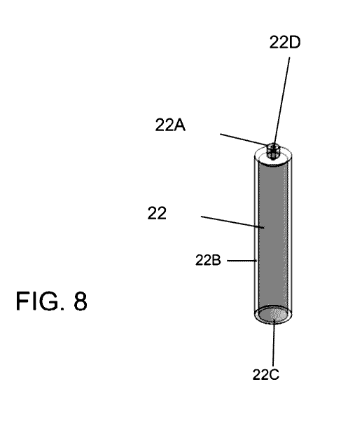

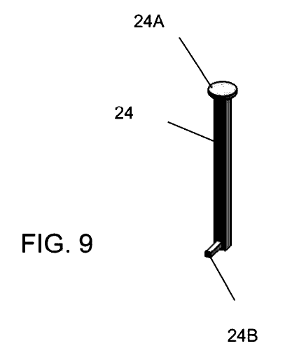

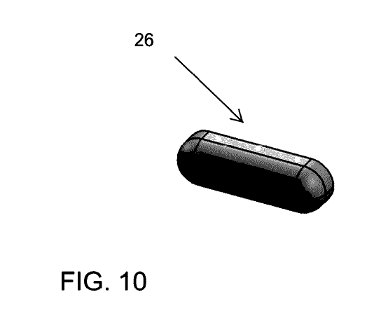

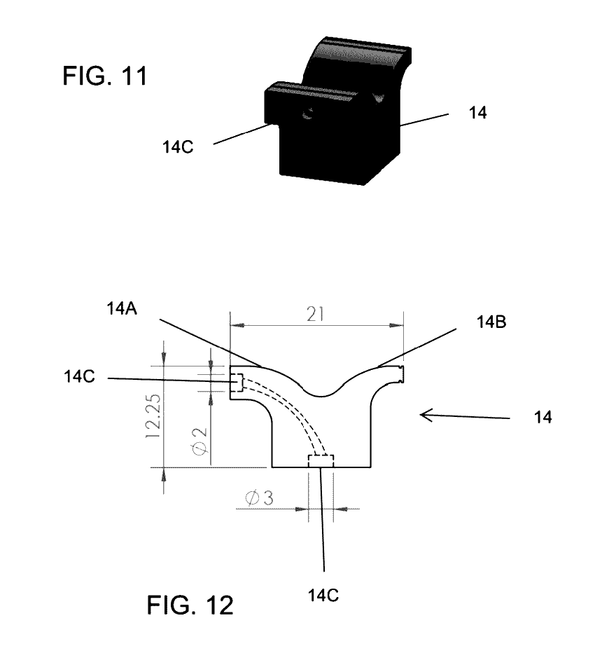

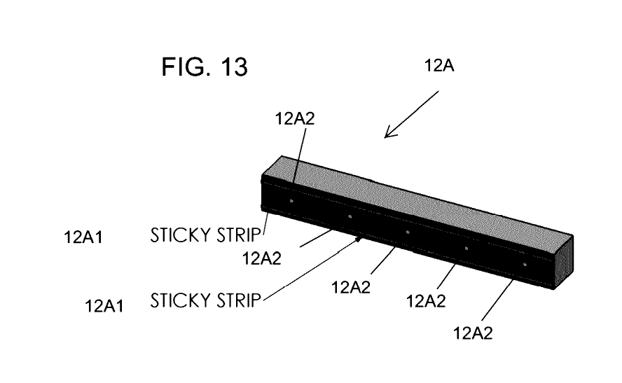

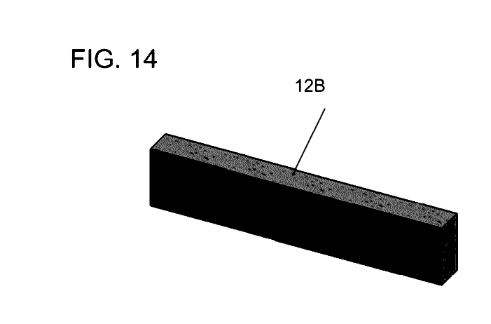

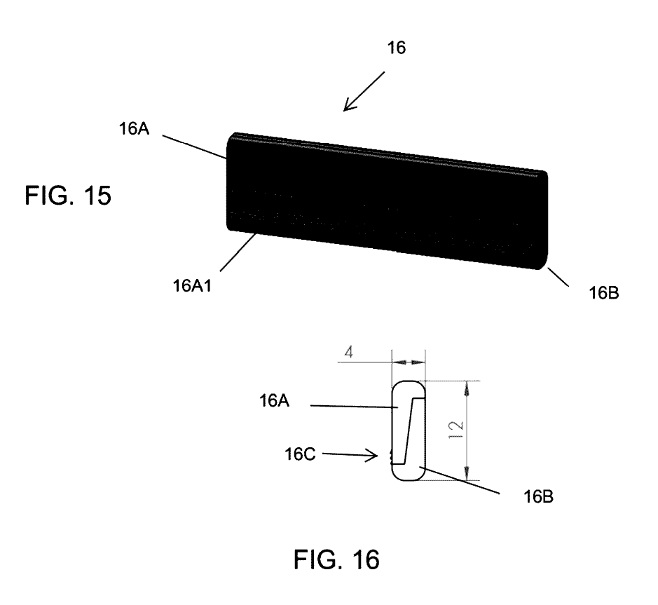

FIG. 7 shows an enlarged view of the mounting plate 20. The mounting plate 20 may have a same perimeter shape as the top of the user handle (18 in FIG. 4) and the mounting head (14 in FIG. 4). An opening 20A may be provided in a suitable position within the perimeter of the mounting plate 20 to enable passage therethrough of a dispensing tip (22A in FIG. 8) of the container (22 in FIG. 3).

An example embodiment of the container 22, e.g., in the form of a cartridge, is shown in FIG. 8. The container 22 may comprise an internal chamber 22B which may be filled with shaving lubricant, e.g., gel. A membrane 22C, such as a thin plastic sheet or disk, may seal the lower portion of the chamber 22B to prevent leakage during transportation and storage prior to use of the shaving razor (10 in FIGS. 1-5). A dispensing tip 22A may provide a fluid conduit through which the contents of the chamber 22B may be discharged upon the membrane 22C being ruptured by pressure applied by the dispensing plunger (see FIG. 2). The dispensing tip 22A may be removably, sealingly affixed to the mounting head (14 in FIG. 4), for example using external threads on the dispensing tip 22A. In such example embodiments, mating threads may be disposed on an interior of the bottom of the mounting head (14 in FIG. 4). In some embodiments, dispensed shaving lubricant may flow through the dispensing tip 22A and into a port (14C in FIG. 12) the mounting head (14 in FIG. 4). The dispensing tip 22A may include a membrane 22D to seal the chamber 22B prior to initial use of the shaving razor or a replacement container, if used, similar to the membrane 22C on the bottom of the container 22. The container 22 may in such embodiments also serve to affix the mounting head (14 in FIG. 4) to the handle (18 in FIG. 4). In some embodiments, once all the shaving lubricant in the container 22 is used, a replacement container may be affixed to the mounting base. It is within the scope of the present disclosure to use additional lubricant applied directly to the applicator (12 in FIG. 2) once the container 22 is empty.

FIG. 9 shows an example embodiment of the dispensing plunger 24. The dispensing plunger 24 may include a plunger disk 24A at one longitudinal end shaped to conform to the interior of the chamber (22B in FIG. 8) in the container (22 in FIG. 8) such that longitudinal movement of the dispensing plunger 24 into the container (22 in FIG. 8) will displace the contained shaving lubricant and cause it to discharge through the dispensing tip (22A in FIG. 8). The dispensing plunger 24 may include a handle tip 24B, which may pass through the slot (18A in FIG. 6) in the handle (18 in FIG. 6) and to which may be affixed the dispensing handle (24B in FIG. 5) to enable ease of movement of the dispensing plunger 24 by the user as needed.

An example embodiment of the dispensing handle is shown at 26 in FIG. 10. The shape of and the dimensions of the dispensing handle 26 are a matter of convenience, ease of use by the user of the shaving razor and choice of appearance by the designer of the razor; the shape and size of the dispensing handle 26 are not intended to limit the scope of the present disclosure.

FIG. 11 shows an oblique view of the mounting head 14. One side of the mounting head 14 may include a port 14C for flow of the shaving lubricant displaced from the container (22 in FIG. 8) into the applicator (12 in FIG. 4). FIG. 12 shows a side sectional view of the mounting head 14 showing the port 14C extending from the base of the mounting head 14 to the side of the mounting head 14 to which the applicator base (12A in FIG. 2) is ultimately affixed.

FIG. 13 shows an example embodiment of the applicator base 12A. The applicator base 12A may be affixed to the mounting base (14 in FIG. 12) by adhesive, thermal bonding or plastic or any other known affixing device, depending on the materials selected for use for the mounting base 14 and the applicator base 12A. The present embodiment of the applicator base 12A may include a plurality of ports 12A2 on one side in fluid communication with a port (not shown in FIG. 13) on the other side. Such port may be in fluid communication with the port (14C in FIG. 12) in the mounting head (14 in FIG. 12) such that discharged shaving lubricant flows through the mounting head (14 in FIG. 12), into the applicator base 12A and is ultimately discharged from each of the ports 12A1 in the applicator base 12A. Adhesive bonding strips 12A2, for example, may be used to affix the applicator (12 in FIG. 4) to the applicator base 12A.

An example embodiment of an applicator 12 is shown in FIG. 14. The applicator 12 may be made from porous, flexible, compressible material such as natural or synthetic sponge or foam such as open cell foam. As the shaving lubricant is discharged from the container (22 in FIG. 8), it is ultimately moved into the applicator 12, where the user may apply the lubricant on the skin area to be shaved. Additional shaving lubricant may be moved into the applicator 12 as needed by the user moving the dispensing handle (24B in FIG. 5) to displace lubricant from the container (22 in FIG. 2).

An example embodiment of the razor blade assembly 16 is shown in FIG. 15. The razor blade assembly 16 may include a plurality of parallel, angularly disposed blades 16C embedded, for example, in a soft, flexible, self-lubricating material blade base 16A such as may be made from certain compositions of plastic. The blade base 16A may be affixed to a blade mounting base 16B, for example made from a more rigid plastic that may be affixed in any manner known in the art to the mounting base (14 in FIG. 1).

A shaving razor according to the present disclosure may provide a self-contained, easy to use combination of razor and shaving lubricant that may eliminate the need for separate containers of shaving lubricant. Such a shaving razor may be transported onboard aircraft within current regulations for transportation of liquid or gel materials.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A shaving razor, comprising:
a razor blade and an applicator mounted to a user handle on opposed sides of one end of the user handle;
a container of shaving lubricant disposed in the user handle;
a dispensing plunger disposed in the user handle and operable to displace shaving lubricant from the container; and
wherein the container is in fluid communication with the applicator whereby displacement of the shaving lubricant from the container moves the shaving lubricant into the applicator.

2. The razor of claim 1 wherein the razor blade and the applicator are mounted to a mounting base having two opposed mounting sides and a base in contact with one end of the user handle.

3. The razor of claim 1 wherein the dispensing plunger has an operating tip extending through a slot in the user handle and a plunger end shaped to conform to an interior chamber of the container.

4. The razor of claim 3 further comprising a plunger handle coupled to the operating tip external to the user handle.

5. The razor of claim 1 wherein the container is removably affixable to the mounting base.

6. The razor of claim 5 wherein the container has an externally threaded dispensing tip threadedly engaged with an opening in the base of the mounting base.

7. The razor of claim 1 further comprising an applicator base coupled to one side of the mounting base, the applicator base having a plurality of ports on another side thereof in contact with the applicator.

8. The razor of claim 1 wherein the applicator comprises at least one of sponge and foam.

9. The razor of claim 1 wherein the razor blade comprises a plurality of parallel, angularly disposed blades embedded in a flexible, compressible material.

10. The razor of claim 1 wherein the container comprises a membrane at at least one end thereof to seal the container prior to operation of the dispensing plunger.
